(19) United States
(12) Patent Application Publication
(10) Pub. No.: US 2015/0356886 A1
(43) Pub. Date: Dec. 10, 2015

(54) CUSTOMIZED APPARATUS AND METHOD FOR MANAGING AN AMOUNT OF MEAL OR WORKOUT

(71) Applicant: ELECTRONICS AND TELECOMMUNICATIONS RESEARCH NSTITUTE, Daejeon (KR)

(72) Inventors: Min Ho KIM, Daejeon (KR); Myung Eun LIM, Daejeon (KR); Jae Hun CHOI, Daejeon (KR); Young Woong HAN, Daejeon (KR)

(21) Appl. No.: 14/735,038

(22) Filed: Jun. 9, 2015

(30) Foreign Application Priority Data
Jun. 9, 2014 (KR) 10-2014-0069478
Mar. 31, 2015 (KR) 10-2015-0045334

(51) Int. Cl. G09B 19/00; G09B 5/00

(52) U.S. Cl. CPC G09B 19/0092; G09B 5/00

(57) ABSTRACT

Provided herein is a customized apparatus and method for managing a meal amount or workout amount of an individual using information communication technology, the apparatus including receiving an input of a subjective meal amount from a user, computing an objective meal amount corresponding to the subjective meal amount, computing an objective workout amount corresponding to the objective meal amount with reference to a managing scenario, and computing a subjective workout amount corresponding to the objective workout amount.

### CROSS-REFERENCE TO RELATED APPLICATION

The present application claims priority to Korean Patent Application Numbers 10-2014-0069478 filed on Jun. 9, 2014 and 10-2015-0045334 filed on Mar. 31, 2015 in the Korean Intellectual Property Office, the entire disclosure of which is incorporated by reference herein.

### BACKGROUND

1. Field of Invention

Various embodiments of the present disclosure relate to a customized apparatus and method for managing an amount of meal or workout, and more particularly, to a customized apparatus for managing an amount of meal or workout of an individual using information communication technology, and a method thereof

2. Description of Related Art

As the material civilization developed and industrial structure became sophisticated, the living environment of human beings and various medical technologies improved, thereby extending the average life expectancy of human beings. Accordingly, there is a growing interest in health so that people can lead enriched lives. Generally, it is well known that of the living habits of a person, the eating habits and activities (workout) are closely related to the health of that person. Therefore, how to manage an amount of meal and workout of a person can be seen as an important factor in managing the health of the person.

Accordingly, in line with this trend, various wearable smart devices capable of measuring the amount of workout of people are being widely commercialized. Nike fuel, Fitbit sensor, and Jawbone Up are cases in point of such smart devices.

However, most of these devices for measuring the amount of workout are based on sensors such as acceleration sensors capable of measuring movements, which means that there is a limitation since such a movement sensor must be utilized every time. Furthermore, these sensors predict the amount of calories spent by a person based on measurements made by the sensors, wherein a predicted value being used is a value designed based on a standard human body that does not appropriately reflect all the different characteristics of individuals. Therefore, there occurs a problem of errors due to deviations for each individual.

Therefore, there is need for a customized apparatus for managing an amount of meal or workout precisely that reflects the different physical characteristics of each individual.

### PRIOR ART DOCUMENTS

### Patent documents

(Patent 1) Korean Patent Registration no.10-0525773 (published on Oct. 8, 2004)

### SUMMARY

A purpose of the present disclosure is to provide a customized apparatus and method for providing a meal amount or workout amount required for an individual.

Another purpose of the present disclosure is to provide a customized apparatus and method for monitoring and managing a meal amount or workout amount of an individual that reflects physical characteristics of the individual.

According to an embodiment of the present disclosure, there is provided a method for managing a meal amount or workout amount, the method including receiving an input of a subjective meal amount from a user; computing an objective meal amount corresponding to the subjective meal amount; computing an objective workout amount corresponding to the objective meal amount with reference to a managing scenario; and computing a subjective workout amount corresponding to the objective workout amount, wherein the subjective meal amount is a value subjectively determined by the user regarding a degree of meal amount taken by the user; the objective meal amount is a value of meal amount expressible in units of heat quantity, such as calorie, the objective workout amount is a value of workout amount expressible in units of heat quantity, and the subjective workout amount is a value determined at least partially by the user's subjective determination regarding a degree of workout amount.

In the embodiment, the computing an objective meal amount may include computing the objective meal amount from the subjective meal amount using a regression equation representing a relationship between the subjective meal amount and the objective meal amount.

In the embodiment, the regression equation may be determined using an ordered pair consisting of the subjective meal amount value of the user and a measured or computed objective meal amount value corresponding to the subjective meal amount value.

In the embodiment, the computing an objective workout amount may include computing the objective workout amount using a relationship equation having one of the objective meal amount or the objective workout amount as an independent variable, and having the other one as a dependent variable.

In the embodiment, the computing a subjective workout amount may include computing the subjective workout amount from the objective workout amount using a regression equation representing the relationship between the objective workout amount and the subjective workout amount.

In the embodiment, the regression equation may be determined using an ordered pair consisting of the subjective workout amount value of the user and the measured or computed objective workout amount value corresponding to the subjective workout amount value.

In the embodiment, the method may further include outputting the computed subjective workout amount.

In the embodiment, the managing scenario may include a target value for weight management of the user or an amount of weight change for achieving the target value.

In the embodiment, the method may further include outputting at least one combination of subjective meal amount and subjective workout amount for achieving the amount of weight change included in the managing scenario with reference to the managing scenario.

In the embodiment, a basal metabolic rate value or workout amount value being referred to for determining the regression equation may be a value predicted using an EM (expectation maximization) method so as to reflect physical characteristics of the user.

According to another embodiment of the present disclosure, there is provided a method for managing a meal amount or workout amount, the method including receiving an input of a subjective workout amount from a user; computing an objective workout amount corresponding to the subjective workout amount; computing an objective meal amount corresponding to the objective workout amount with reference to a managing scenario; and computing a subjective meal amount corresponding to the objective meal amount, wherein the subjective workout amount is a value subjectively determined by the user regarding a degree of workout amount done, the objective workout amount is a value of workout amount expressible in units of heat quantity, such as, calorie, the objective meal amount is a value of meal amount expressible in units of heat quantity, and the subjective meal amount is a value determined at least partially by the user's subjective determination regarding a degree of meal amount.

According to the aforementioned embodiments of the present disclosure, a customized amount of meal or workout needed for an individual may be provided.

Furthermore, by objectifying an amount of meal or workout that an individual feels subjectively, it is possible to predict or calculate changes in weight with only a subjective determination of an individual, and further, it is possible to manage the weight without having to regularly measure one's weight.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram of a configuration of an apparatus for managing a meal amount or workout amount for each individual according to an embodiment of the present disclosure;

FIG. 2 is a flowchart of a method for computing an equation for a meal amount of an individual according to an embodiment of the present disclosure;

FIG. 3 is a flowchart of a method for computing an equation for a workout amount of an individual according to an embodiment of the present disclosure; and

FIGS. 4 and 5 are flowcharts of a customized method for managing a meal amount or workout amount of an individual using the equation for a meal amount or workout amount of each individual of FIGS. 2 and 3.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

The present disclosure relates to an apparatus and method for managing eating habits and activity habits based on input values of an amount of meal or workout that an individual subjectively feels. Since a subjective input value that an individual inputs depends on personal feeling or subjective judgment, it may be essentially different from an objectively digitized amount of meal or workout (for example, expressed in calories or metabolic load). However, since the subjective input value is based on senses felt by one's body, it has an advantage that it can reflect the eating habits and workout habits of each person.

Thus, the present disclosure intends to provide a method capable of reflecting eating habits and workout habits of an individual while obtaining objectivity of a result value by converting a subjective input value of an individual into an objective figure (or hereinafter referred to as ‘objectifying a subjective input value’).

Specific explanation on how the subjective input value is objectified and how an amount of meal or workout of an individual is managed will be provided hereinbelow with reference to the attached drawings together with explanation on various embodiments.

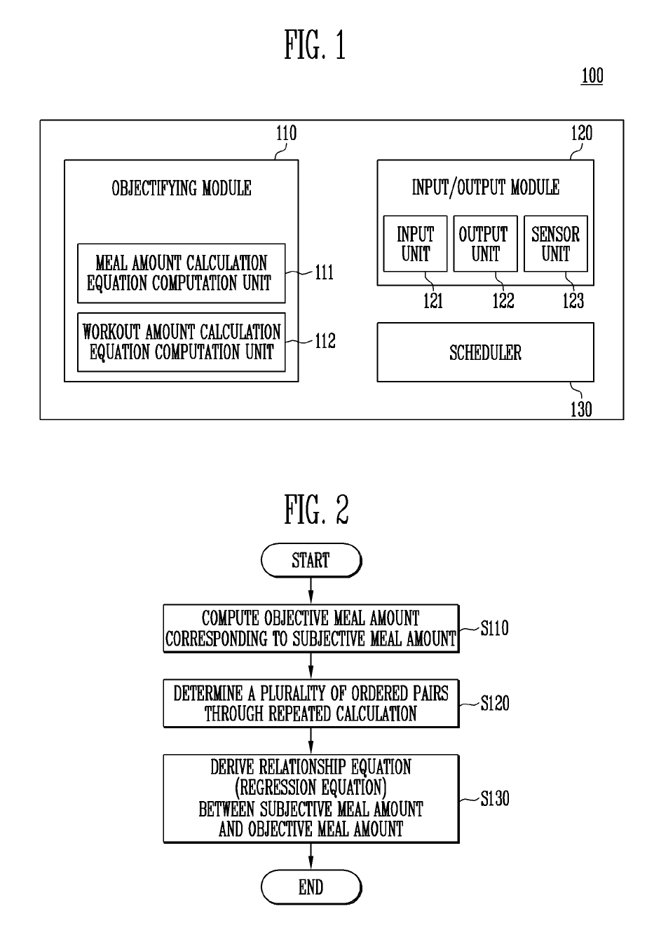

FIG. 1 is a block diagram illustrating a configuration of an apparatus for managing a meal amount or workout amount according to an embodiment of the present disclosure. Referring to FIG. 1, the apparatus for managing a meal amount or workout amount 100 includes an objectifying module 110, input/output module 120, and scheduler 130.

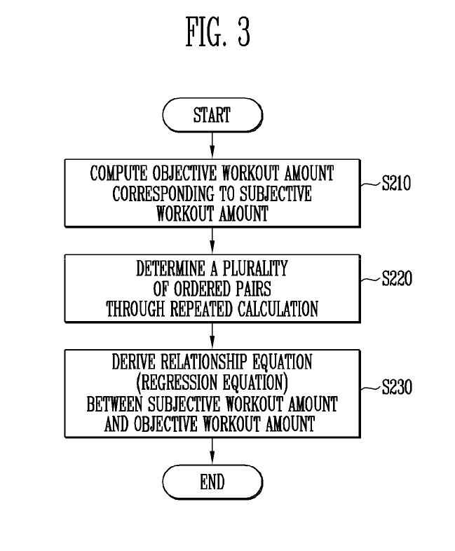

FIG. 1 is an exemplary illustration of hardware/software components needed in the managing apparatus 100 according to the present disclosure. FIG. 1 focuses on what kind of components the managing apparatus 100 includes and what functions the components perform. Explanation regarding FIGS. 2 to 5 that will be made later on will be dealt briefly with reference to FIG. 1 or will be omitted in order to avoid repeated explanation. For example, explanation on specific methods and algorithms by which the functions of each component 110, 120, 130 are achieved will be made with reference to FIGS. 2 to 5 later on.

Hereinbelow, explanation on the components of FIG. 1 will be made.

The objectifying module 110 provides means or conversion equations for converting a value subjectively determined based on one's feeling into an objectified figure.

For example, the objectifying module 110 may include a meal amount calculation equation computation unit 111 configured to provide means or conversion equations for converting a subjectively determined figure (hereinafter referred to as ‘subjective meal amount’) of one's amount of meal into an objectified figure (for example, calories).

Otherwise, the objectifying module 110 may include a workout amount calculation equation computation unit 112 configured to provide means or conversion equations for converting a subjectively determined figure (hereinafter referred to as ‘subjective workout amount’) of one's amount of workout into an objectified figure (for example, calories or metabolic load).

The input/output module 120 provides means for the managing apparatus 100 to interface with a user or external environment. The input/output module 120 may include an input unit 121, output unit 122 or sensor unit 123.

The input unit 121 receives from the user an input value (for example, subjective meal amount or subjective workout amount) that is needed. For this purpose, the input unit 121 may include a keyboard, mouse, touch sensing apparatus, voice recognition apparatus, wireless data receiving apparatus or motion recognition apparatus and the like.

The output unit 122 outputs operations or results of the managing apparatus 100 to the user. For this purpose, the output unit 122 may include outputting means, for example, a monitor, LED, printer, speaker, wireless data transceiving apparatus or a display apparatus using mechanical movements.

The sensor unit 123 senses an external environment or external signals necessary for driving or operating the managing apparatus 100. For example, the sensor unit 123 may include an acceleration sensor configured to sense the amount of workout of the user (if not customized data).

The scheduler 130 determines a recommended amount of meal or workout that is suitable to a predetermined meal amount or workout amount managing scenario with reference to conversion means or equations provided by the objectifying module 110. The recommended meal amount or workout amount determined through the scheduler 130 may be provided to the user through the output unit 122.

Herein, the recommended meal amount or workout amount may be determined in response to the user's subjective meal amount or subjective workout amount that is input through the input/output module 120. For example, when a certain figure is input as the user's subjective meal amount, the scheduler 130 may calculate and determine a recommended workout amount that is suitable to a predetermined workout amount managing scenario and provide the same to the user. In another example, when a certain figure is input as a subjective workout amount of the user, the scheduler 130 may calculate and determine a recommended meal amount suitable to the predetermined meal amount managing scenario and then provide the same to the user.

Furthermore, the scheduler 130 may calculate or predict a weight or change of weight of the user based on the input subjective meal amount or subjective workout amount. The calculated or predicted weight value or change of weight of the user may be provided to the user as additional information, or may be referred to by the scheduler 130 for its operation.

According to the aforementioned configuration, the meal amount or workout amount managing apparatus 100 may provide a customized meal amount or workout amount necessary for an individual. Furthermore, it is possible to monitor and manage the eating habits and activity habits of the individual in a customized way through the method of calculating the meal amount and workout amount reflecting physical characteristics of the individual.

Furthermore, by objectifying the meal amount and workout amount that an individual subjectively feels, it becomes possible to predict or calculate changes of weight of the individual by simply inputting the subjective meal amount or subjective workout amount. Therefore, the user may manage one's weight without having to measure the weight regularly.

FIG. 2 is a flowchart of a method for computing an equation for a meal amount of each individual according to an embodiment of the present disclosure. Referring to FIG. 2, the method for computing an equation for a meal amount of each individual includes steps S110 to S130.

At step S110, an objectified actual meal amount (hereinafter referred to as objective meal amount) corresponding to a subjective meal amount is computed.

Specifically, first of all, the individual subjectively determines the amount of meal that he/she has taken, that is, determines or inputs a subjective meal amount. In an embodiment, the determining or inputting of a subjective meal amount may be performed by selecting or inputting one of a plurality of values representing degrees of meal amount taken. For example, supposing subjective meal amounts can be classified into 1 to 5 according to amounts taken, an individual may determine or input ‘1’ for ‘very little’, ‘2’ for ‘little’, ‘3’ for ‘normal’, ‘4’ for ‘much’, and ‘5’ for ‘very much’ for his/her amount of meal taken. Furthermore, if the individual did not eat at all, he/she may determine or input ‘0’.

Furthermore, it is possible to measure a weight and workout amount of an individual, and calculate an objective meal amount through a predetermined calculation equation, and then determine the calculated objective meal amount as a value corresponding to the subjective meal amount input. Herein, the predetermined calculation equation may be one that has been determined by the following method.

Amount of weight changed=objective meal amount−basal metabolic rate−workout amount [Math equation 1]

However, the amount of weight changed, objective meal amount, basal metabolic rate and workout amount may all be converted into calories and then used, for convenience of calculation.

From math equation 1, it is possible to derive math equation 2 that is based on an objective meal amount as shown below.

Objective meal amount=amount of weight changed+basal metabolic rate+workout amount [Math equation 2]

Herein, if it is possible to find out the amount of weight change, basal metabolic rate and workout amount through measurement or estimation, the objective meal amount of the individual may be calculated according to math equation 2.

For example, the amount of weight change may be calculated from a difference of a weight measured at a certain point in the past and a current weight. Herein, an interval between the points of measuring the weight may be stored or determined so as to be referred to when measuring or computing the basal metabolic rate and workout amount. In order to prevent calculation error, it is desirable to adjust such that there is one meal or less between the points when the weights were measured.

Since weight is generally measured by a weight unit (for example, kg), in order to apply an amount of weight change to math equation 2, it is necessary to convert the measured or calculated value into units of heat quantity (for example, calories). Such a conversion of weight from a weight unit to heat quantity unit is performed by the following estimation and calculation.

A change in the amount of weight means that the total weight without fat and the body fat that includes an amount of muscles have changed. However, since the amount of muscles does not change significantly at a short period of time unless the person particularly exercised the muscles, the amount of weight change may be understood as meaning the change in body fat. Since 1 g of fat may be converted into heat quantity of 9 cal (=kcal) and since 87% of fat tissue is lipid, the amount of weight change may be converted into calories by math equation 3 shown below.

Amount of weight change (Cal)=amount of weight change (g)×9×0.87 [Math equation 3]

Next, the basal metabolic rate may be calculated by math equation 4 shown below with reference to an interval between a previous point of weight measurement and current weight measurement.

Basal metabolic rate=daily basal metabolic rate×interval/24 [Math equation 4]

Herein, the daily basal metabolic rate may be the standard basal metabolic rate that is provided according to age, gender, height, or weight of an individual. Otherwise, a customized basal metabolic rate value designed for each individual may be used as the daily basal metabolic rate value. The method for computing the customized basal metabolic rate value will be explained in detail in the latter part of the specification, and thus will be omitted herein to avoid repetition of explanation.

Lastly, the workout amount may be a value measured by a workout amount sensor such as an acceleration sensor. For example, the workout amount may be converted from the value measured by a workout amount sensor using a regression equation. Standardized regression equations and methods for measuring a workout amount using the regression equations are well known techniques in the related art, and thus detailed explanation will be omitted herein. However, instead of using such a general method for measuring a workout amount, a customized workout amount measuring method designed for each individual may be used. The customized workout amount measuring method will be explained in detail in the latter part of the specification, and thus will be omitted herein to avoid repetition of explanation.

By using the methods for measuring an amount of weight change, basal metabolic rate, and workout amount explained so far, an objective meal amount of an individual may be calculated based on math equation 2. Such an objective meal amount corresponds to the subjective meal amount input by the individual, that is, it is an objectified value of the subjective meal amount. For example, when an individual inputs ‘2’(little) as a subjective meal amount, this does not have objectivity since it is based on a subjective feeling, but as an objective meal amount is calculated through math equation 2 and then the result value is matched to the input subjective meal amount value ‘2’, the subjective meal amount value of the individual ‘2’ is matched to a certain level of objective meal amount value (objectification of subjective meal amount).

At step S120, by repeating the above calculation, a plurality of ordered pairs of subjective meal amounts to objective meal amounts are obtained.

Specifically, an objective meal amount corresponding to the subjective meal amount obtained at step S110 may be defined as one ordered pair as shown in math equation 5 below.

(x,y)=(subjective meal amount, objective meal amount) [Math equation 5]

Furthermore, this method of obtaining an ordered pair may be repeated so as to obtain a plurality of ordered pairs. Group A of N ordered pairs obtained by this method may be represented by math equation 6 shown below.

A={(xᵢ, yᵢ), 1≦i≦N} [Math equation 6]

Herein, (xᵢ, yᵢ)=(i^{th} subjective meal amount, i^{th} objective meal amount)

An ordered pair or group obtained as above may be stored in the managing apparatus 100 (for example, in the objectifying module 110).

At step S130, using the ordered pairs obtained at step S120, a relationship equation (or its coefficient) representing a relationship between subjective meal amounts and objective meal amounts of the individual is computed.

Specifically, this relationship equation may be a regression equation for each individual that could change a subjective meal amount(x) into an objective meal amount(y). This may be represented by math equation 7 shown below.

a₁·x+a₂·x²+ . . . +aₖ·x^{k}+b=y. [Math equation 7]

Herein, k is a degree of the regression equation for each individual. For example, supposing a one-dimensional regression equation, math equation 7 may be represented by math equation 8 shown below.

a₁·x+b=y [Math equation 8]

Now, if only the coefficients of the above regression equation are determined, it will be possible to convert a subjective meal amount(x) into an objective meal amount(y) or vice versa using math equations 7 and 8. For the method for calculating the coefficients of the regression equation, the least square method may be used. Herein, the data needed for making the least square method calculation is the ordered pairs group A={(xᵢ, yᵢ), 1≦i≦N} computed at step S120, and by applying the least square method using each ordered pair, it is possible to determine the coefficients of the regression equation.

The least square method is a well known mathematical solution in the related field, and it is a well known fact that coefficients can be determined using the least square method. However, the least square method will be explained hereinbelow for better understanding.

Supposing there is a function relationship between two variables x and y, the least square method is generally used to identify the relationship in a quantitative manner. It is the most commonly used method for obtaining coefficients of a regression equation in regression analysis, and is often called OLS (ordinary least square). This is a method of obtaining a regression coefficient(a₁, a₂, . . . , aₖ, b) where a difference between a value (yᵢ) of an actual dependent variable that corresponds to a certain independent variable value (xᵢ) and a theoretical dependent variable value (ŷᵢ) obtained from the regression equation becomes a minimum value. That is, it is a method of obtaining a regression coefficient where a sum of square of the difference between the value obtained from the regression equation and the actual value is a minimum value, and for this purpose, the equation of sum of square is partially differentiated, and then a value that makes the regression coefficient zero (0) is obtained.

When the regression equation coefficient (a₁, a₂, . . . , aₖ, b) of each individual is obtained by the aforementioned method, math equations 7 and 8 are completed, and it becomes possible to calculate an objective meal amount from a subjective meal amount using the completed math equations 7 and 8 (hereinafter referred to as ‘meal amount calculation equation for each individual).

Meanwhile, the managing apparatus 100 may be configured such that all the aforementioned steps S110 to S130 are performed by the objectifying module 110 that the managing apparatus 100 includes. Otherwise, it may be configured such that the steps S110 to S130 are performed by another apparatus or an external apparatus, and the relationship equation or coefficient computed by the steps S110 to S130 are stored in the objectifying module 110 so that the managing apparatus 100 operates by referring to the relationship equation or coefficient stored in the objectifying module 110 in subsequent operations.

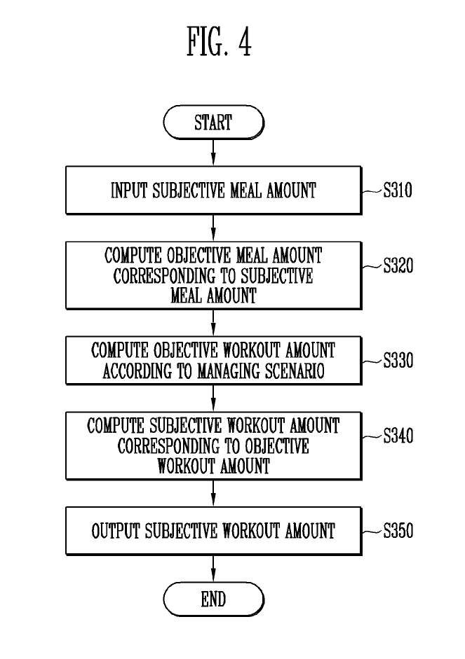

FIG. 3 is a flowchart of a method for computing a workout amount of each individual according to an embodiment of the present disclosure. Referring to FIG. 3, the method for computing a workout amount of each individual includes steps S210 to S230.

The method for computing a workout amount calculation equation of each individual is generally similar to the method for computing a meal amount calculation equation for each individual illustrated in FIG. 2. Therefore, in order to avoid obscuring the point of explanation, explanation on configurations that overlap with FIG. 2 will be omitted, but will be made with a main focus on new or different characteristics.

At step S210, an objectified actual workout amount (hereinafter referred to as objective workout amount) that corresponds to a subjective workout amount of an individual is computed.

Specifically, first of all, the individual subjectively determines the workout amount that he/she has done, that is, determines or inputs a subjective workout amount. In an embodiment, the determining or inputting of a subjective workout amount may be performed by selecting or inputting one of a plurality of values representing degrees of workout amount that he/she has done. For example, supposing subjective workout amounts can be classified into 1 to 5 according to amounts done, the individual may determine or input ‘1’ for ‘very little’, ‘2’ for ‘little’, ‘3’ for ‘normal’, ‘4’ for ‘much’, and ‘5’ for ‘very much’ for his/her amount of workout done. Furthermore, if the individual did not workout at all, he/she may determine or input ‘0’.

Furthermore, an objective workout amount of the individual is measured or calculated, and the result is determined as a value that corresponds to a previously input subjective workout amount. Herein, the objective workout amount may be measured by a workout amount sensor such as the acceleration sensor as mentioned with reference to FIG. 2. For example, the objective workout amount may be determined by converting the value measured by the workout amount sensor into a workout amount using a standardized regression equation. Otherwise, instead of the general workout amount measuring method that uses the acceleration sensor, a customized workout amount measuring method designed for each individual may be used. As mentioned with reference to FIG. 2, the customized workout amount measuring method will be explained in the latter part of this specification, and thus detailed explanation will be omitted herein.

By the aforementioned method, at step S210, an objective workout amount value that corresponds to the subjective workout amount of the individual may be computed or determined.

At step 220, by repeating the above calculation, a plurality of ordered pairs of subjective workout amounts to objective workout amounts are obtained.

Specifically, the objective workout amount corresponding to the subjective workout amount obtained at step S210 may be defined as one ordered pair as shown in math equation 9 below.

(p,q)=(subjective workout amount, objective workout amount) [Math equation 9]

Furthermore, this method of obtaining an ordered pair may be repeated so as to obtain a plurality of ordered pairs. Group B of M ordered pairs obtained by this method may be represented by math equation 10 shown below.

B={(pᵢ, qᵢ), 1≦i≦M} [Math equation 10]

Herein, (pᵢ, qᵢ)=(i^{th} subjective workout amount, i^{th} objective workout amount)

An ordered pair or group obtained as above may be stored in the managing apparatus 100 (for example, in the objectifying module 110).

At step S230, using the ordered pairs obtained at step S220, a relationship equation (or a coefficient) representing a relationship between subjective workout amounts and objective workout amounts of the individual is computed.

Specifically, this relationship equation may be a regression equation for each individual that could change a subjective workout amount (p) into an objective workout amount (q). This may be represented by math equation 11 shown below.

c₁·p+c₂·p²+ . . . +cₖ·p^{k}+d=q [Math equation 11]

Herein, k is a degree of the regression equation for each individual. For example, supposing a one-dimensional regression equation, math equation 11 may be represented by math equation 12 shown below.

c₁·p+d=q [Math equation 12]

Furthermore, regression coefficients (c₁, c₂, . . . , cₖ, d) of math equations 11 and 12 are determined using the least square method as in FIG. 2, and the data needed for making the least square method calculation is the ordered pairs group B={(pᵢ, qᵢ), 1≦i≦M}.

In an embodiment, math equations 11 and 12 may be converted into math equations 13 and 14, respectively, in order to reflect a workout time (exercise time) into the regression equation.

(c₁·p+c₂·p²+ . . . +cₖ·p^{k})·t+d=q [Math equation 13]

c₁·p·t+d=q [Math equation 14]

When the regression equation coefficient (c₁, c₂, . . . , cₖ, d) of each individual is obtained through the least square method, the aforementioned math equations 11 to 14 are completed, and it becomes possible to calculate the objective workout amount from the subjective workout amount using the completed math equations 11 to 14 (hereinafter referred to as ‘workout amount calculation equation for each individual’).

Meanwhile, as explained above, the managing apparatus 100 may be configured to perform all the steps from S210 to S230, or to only store and use the computed relationship equation and its coefficient.

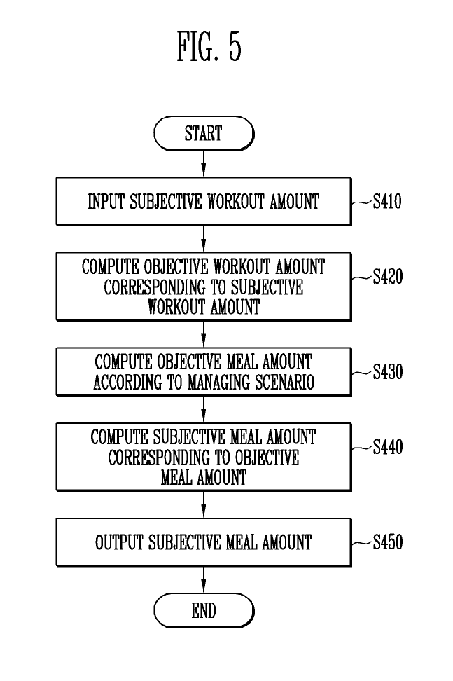

FIGS. 4 and 5 are flowcharts of a customized method for managing a meal amount or workout amount of each individual using the meal amount calculation equation or workout amount calculation equation of each individual of FIGS. 2 and 3.

Supposing that a scenario for managing the meal amount or workout amount of each individual is a scenario for managing such that a change of weight is zero (0) (that is, a scenario for maintaining the weight, a target weight change being zero(0)), in an embodiment, the managing scenario may be stored in the scheduler 130 of the managing apparatus 130. Hereinbelow, explanation will be made with reference to FIGS. 4 and 5 based on this supposition.

FIG. 4 is a flowchart of a method for computing a target workout amount when a meal amount has been determined. Referring to FIG. 4, the method for computing a target workout amount includes steps S310 to S350.

At step S310, the user inputs into the managing apparatus 100 a subjective meal amount (x) that is a subjectively determined value regarding the meal amount that he/she has taken (see FIG. 1). Herein, the managing apparatus 100 may receive the subjective meal amount through the input/output module 120 (see FIG. 1).

At step S320, the managing apparatus 100 computes an objective meal amount (y) that corresponds to the input subjective meal amount (x) using the pre-stored regression equation or regression coefficient. For example, by substituting the subjective meal amount (x) to math equations 7 and 8, it is possible to compute the objective meal amount (y) as a result value.

At step S330, an objective workout amount (q) for making the weight change zero (0) according to the objective meal amount (y) computed in the managing apparatus 100 is computed. The relationship between the objective meal amount (y) and the objective workout amount (q) may be defined as math equation 15 shown below.

Objective workout amount (q)=objective meal amount (y)−amount of weight change−basal metabolic rate [Math equation 15]

Herein, since the weight change according to the managing scenario is zero (0), math equation 15 is simplified as shown below.

Objective workout amount (q)=objective meal amount (y)−basal metabolic rate [Math equation 16]

Herein, since the basal metabolic rate is a value pre-computed or stored by the method explained with reference to FIG. 2, the objective workout amount (q) may be computed right away by substituting the objective meal amount (y) to math equation 16.

At step S340, the managing apparatus 100 computes the subjective workout amount (p) corresponding to the previously computed objective workout amount (q). Just as in the regression equation (or regression coefficient) regarding the meal amount, the regression equation (or regression coefficient) regarding the workout amount is already obtained and stored, and thus by using the regression equation (or regression coefficient) regarding the stored workout amount, it is possible to compute the subjective workout amount (p) corresponding to the objective workout amount (q).

At step S350, the managing apparatus 100 outputs the subjective workout amount (p) computed through the input/output module 120 to the user. The user performs his/her workout (exercise) with reference to the output subjective workout amount (p). For example, if the output subjective workout amount (p) is ‘4’, it means ‘much’, and thus the user will only have to perform workout (exercise) ‘much’ according to what he/she subjectively thinks as being ‘much’ in order to make his/her change of weight zero(0).

FIG. 5 is a flowchart of a method for computing a target meal amount once a workout amount has been determined. Referring to FIG. 5, the method for computing a target meal amount includes steps S410 to S450.

At step S410, the user inputs into the managing apparatus 100 a subjective workout amount (p) that is a subjectively determined value regarding the workout amount (exercise amount) that he/she has done. Herein, the managing apparatus 100 may receive the subjective workout amount through the input/output module 120.

At step S420, the managing apparatus 100 computes an objective workout amount (q) that corresponds to the input subjective workout amount (p) using the pre-stored regression equation or regression coefficient of each individual. For example, when the subjective workout amount (p) is substituted to the math equations 11 to 14, the objective workout amount (p) may be computed as a result value.

At step S430, the managing apparatus 100 computes an objective meal amount (y) for making the change of weight to zero (0) according to the computed objective workout amount (p). The relationship between the objective workout amount (q) and the objective meal amount (y) may be defined as math equation 17 shown below.

Objective meal amount (y)=objective workout amount (q)+amount of weight change+basal metabolic rate [Math equation 17]

Herein, since the change of weight in the managing scenario is 0, math equation 17 is simplified as in math equation 18 shown below.

Objective meal amount (y)=objective workout amount (q)+basal metabolic rate [Math equation 18]

Herein, since the basal metabolic rate is a value pre-computed or stored by the method explained with reference to FIG. 2, by substituting the objective workout amount (q) to math equation 18, it is possible to compute the objective meal amount (y) right away.

At step S440, the managing apparatus 100 computes the subjective meal amount (x) that corresponds to the previous computed objective meal amount (y). Just as the regression equation (or regression coefficient) regarding the workout amount, the regression equation (or regression coefficient) regarding the meal amount is also pre-obtained and stored, and thus by using the regression equation (or regression coefficient) regarding the stored meal amount, it is possible to compute the subjective meal amount (x) that corresponds to the objective meal amount (y).

At step S450, the managing apparatus 100 outputs the subjective meal amount (x) computed through the input/output module 120 to the user. The user becomes able to adjust his/her meal amount with reference to the output subjective meal amount (x). For example, when the output subjective meal amount (x) value is ‘1’, it means ‘little’, and thus the user has only to take ‘little’ meal according to what he/she subjectively thinks as being ‘little’ in order to make his/her change of weight zero(0).

According to the method of FIGS. 4 and 5, it is possible to manage weight stably without having to measure the weight with a scale. That is, referring to math equations 1 to 18, when there are subjective meal amount (or objective meal amount), basal metabolic rate, and subjective workout amount (or objective workout amount), and an interval from the previous point of measuring the weight, the user may calculate changes of weight since the previous point to the current point. The user may check the change of weight, and if the change of weight is a positive value, then the user may adjust his/her weight with a plan to reduce the meal amount and increase the workout amount for the next day. Herein, the scheduler 130 may calculate pairs of subjective meal amount and subjective workout amount necessary to maintain the change of weight to zero (0), and provide a part of the calculated pairs as a scenario of combinations of the subjective meal amount and subjective workout amount for achieving the target (that is, for maintaining the change of weight to zero (0)). The user may select a scenario suitable to his/her environment and taste from the provided scenario of combinations, and adjust the meal amount and workout amount accordingly, so as to manage the change of weight to be close to zero (0).

The aforementioned explanation was based on an assumption that the target change of weight is 0, but there is no limitation to the target change of weight in the present disclosure. For example, the user may select a managing scenario that has a target change of weight other than zero (0). For example, if the user wants to gain weight, he/she may set up the target change of weight to a positive value, and if the user wants to lose weight, he/she may set up the target change of weight to a negative value. In this case, the target change of weight having a value other than zero (0) may be substituted to a relevant term of math equations 15 and 17, so as to be reflected when computing the subjective meal amount (x) or subjective workout amount (p).

Even in this case, the scheduler 130 may receive a target change of weight for weight loss or weight gain, and a target period of time, and automatically provide a scenario of meal amount and workout amount suitable to the target change of weight. Of course, various combinations of meal amount and workout amount may be presented as well, and the user may select one of the suggestions and manage his/her weight.

In an embodiment, when generating a scenario of combinations of meal amount and workout amount, the scenario may be generated taking into account leisure patterns such as the available exercising time.

Hereinbelow, a customized method for measuring a basal metabolic rate and workout amount for each individual will be explained in addition.

A basal metabolic rate is generally calculated based on the gender, age, height and weight. For example, a basal metabolic rate for a male may be calculated by math equation 19 shown below, while a basal metabolic rate for a female may be calculated by math equation 20 shown below.

Basal metabolic rate (male)=66.47+13.75×weight+5×height−6.76×age [Math equation 19]

Basal metabolic rate (female)=65.61+9.65×weight+1.85×height−4.68×age [Math equation 20]

However, these calculation equations for basal metabolic rate are equations standardized based on an average person, and thus they cannot be regarded as reflecting physical characteristics of each individual. Thus, in order to customize the equations to each individual, the constants applied to the gender, weight, height and age need to be re-defined.

These values may be re-defined when using math equation 1. However, in order to use math equation 1, other values defined in math equation 1 must be exact values. Of these, the change of weight can be obtained exactly by measuring the weight. An objective meal amount can be obtained by taking the food prepared according to the calculated calories. However, the workout amount is a value predicted based on the workout amount sensor, that is, it is also based on a regression equation standardized based on an average person. In other words, since the workout amount does not take into account characteristics of each individual, it cannot reflect the deviation caused by different physical characteristics of each individual.

The workout amount is generally obtained by using the regression equation that is based on the measurement by the acceleration sensor. For example, supposing the measurement by the acceleration sensor is r, and the workout amount is s, the regression equation may be represented by math equation 21 shown below.

s=e₁·r+e₂·r²+ . . . +eₖ·r^{k}+f [Math equation 21]

Therefore, in order to calculate the exact basal metabolic rate, it is necessary to compute the exact workout amount, and in order to obtain the exact workout amount, an exact basal metabolic rate is needed. That is, in the exactness of calculation, the two variables are mutually dependent on each other and affecting each other.

A method proposed to solve this problem is the EM (Expectation Maximization) method.

EM method is a well known method in the related art, and thus to briefly explain it, it is a method where a prediction on the regression equation of basal metabolic rate is made on an assumption that the workout amount is the exact amount, and a prediction on the regression equation of the workout amount is made on an assumption that the basal metabolic rate is the exact amount. The two regression equations are sequentially performed alternately to repeat updating each one. This repeated updating is terminated when a difference between a new workout amount prediction and a previous workout prediction after updating the coefficient of the workout amount prediction equation is less than a threshold value (e) defined by the user. The data that may be used in the updating may be the workout amount values or data related to the workout amount values measured by repeatedly a plurality of times (for example. 30 times or more).

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for managing a meal amount or workout amount, the method comprising:
receiving an input of a subjective meal amount from a user;
computing an objective meal amount corresponding to the subjective meal amount;
computing an objective workout amount corresponding to the objective meal amount with reference to a managing scenario; and
computing a subjective workout amount corresponding to the objective workout amount,
wherein the subjective meal amount is a value subjectively determined by the user regarding a degree of meal amount taken by the user;
the objective meal amount is a value of meal amount expressible in units of heat quantity,
the objective workout amount is a value of workout amount expressible in units of heat quantity, and
the subjective workout amount is a value determined at least partially by the user's subjective determination regarding a degree of workout amount.

2. The method according to claim 1,
wherein the computing an objective meal amount comprises computing the objective meal amount from the subjective meal amount using a regression equation representing a relationship between the subjective meal amount and the objective meal amount.

3. The method according to claim 2,
wherein the regression equation is determined using an ordered pair consisting of the subjective meal amount value of the user and a measured or computed objective meal amount value corresponding to the subjective meal amount value.

4. The method according to claim 1,
wherein the computing an objective workout amount comprises computing the objective workout amount using a relationship equation having one of the objective meal amount and the objective workout amount as an independent variable, and having the other one as a dependent variable.

5. The method according to claim 1,
wherein the computing a subjective workout amount comprises computing the subjective workout amount from the objective workout amount using a regression equation representing the relationship between the objective workout amount and the subjective workout amount.

6. The method according to claim 5,
wherein the regression equation is determined using an ordered pair consisting of the subjective workout amount value of the user and the measured or computed objective workout amount value corresponding to the subjective workout amount value.

7. The method according to claim 1,
further comprising outputting the computed subjective workout amount.

8. The method according to claim 1,
wherein the managing scenario comprises a target value for weight management of the user or an amount of weight change for achieving the target value.

9. The method according to claim 1,
further comprising outputting a target value for weight management of the user or at least one combination of subjective meal amount and subjective workout amount for achieving the amount of weight change included in the managing scenario with reference to the managing scenario.

10. The method according to claim 2,
wherein a basal metabolic rate value or workout amount value being referred to for determining the regression equation is a value predicted using an EM (expectation maximization) method so as to reflect physical characteristics of the user.

11. A method for managing a meal amount or workout amount, the method comprising:
receiving an input of a subjective workout amount from a user;
computing an objective workout amount corresponding to the subjective workout amount;
computing an objective meal amount corresponding to the objective workout amount with reference to a managing scenario; and
computing a subjective meal amount corresponding to the objective meal amount,
wherein the subjective workout amount is a value subjectively determined by the user regarding a degree of workout amount done,
the objective workout amount is a value of workout amount expressible in units of heat quantity,
the objective meal amount is a value of meal amount expressible in units of heat quantity, and
the subjective meal amount is a value determined at least partially by the user's subjective determination regarding a degree of meal amount.
